(19) United States
(12) Patent Application Publication
(10) Pub. No.: US 2008/0309216 A1
(43) Pub. Date: Dec. 18, 2008

(54) LIGHT EMISSION DEVICE AND DISPLAY DEVICE USING THE LIGHT EMISSION DEVICE AS A LIGHT SOURCE

(75) Inventors: Zin-Min PARK, Yongin-si (KR); Seung-Joon Yoo, Yongin-si (KR); Jung-Ho Kang, Yongin-si (KR); Su-Kyung Lee, Yongin-si (KR); Won-Il Lee, Yongin-si (KR); Yun-Hee Kim, Yongin-si (KR); Da-Ki Min, Yongin-si (KR); Ji-Ryong Jung, Yongin-si (KR); Kyu-Won Jung, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/928,266

(22) Filed: Oct. 30, 2007

(30) Foreign Application Priority Data
Jun. 12, 2007 (KR) 10-2007-0057261

(51) Int. Cl. G09G 3/10; H01J 1/62

(52) U.S. Cl. 313/496; 315/169.1

(57) ABSTRACT

A light emission device in which a light emission unit has an improved structure and a display device using the light emission device as a light source. The light emission device includes first and second substrates facing each other with a predetermined distance therebetween, an electron emission unit located on one side of the first substrate, and a light emission unit located on one side of the second substrate. The electron emission unit includes a plurality of electron emission elements. The light emission unit includes at least one phosphor layer and a reflection layer spaced apart from the phosphor layer with a barrier disposed between the phosphor layer and the reflection layer.

### CROSS-REFERENCE TO RELATED APPLICATIONS

This application claims the benefit of Korean Application No. 2007-57261, filed Jun. 12, 2007 in the Korean Intellectual Property Office, the disclosure of which is incorporated herein by reference.

### BACKGROUND OF THE INVENTION

1. Field of the Invention

The present invention relates to a light emission device and a display device using the light emission device as a light source. More particularly, the present invention relates to a light emission unit that is provided in the light emission device to emit visible light.

2. Description of the Related Art

There are many different types of light emission devices that radiate visible light. One type of light emission device includes a structure in which a light emission unit having a phosphor layer and an anode electrode is disposed on a front substrate and an electron emission unit having a plurality of electron emission elements is disposed on a rear substrate. The front and rear substrates are sealed to each other at their peripheries using a sealing member, and the inner space between the front and rear substrates is exhausted to form a vacuum vessel (or chamber).

A field emission array (FEA) type of electron emission element and a surface-conduction emission (SCE) type of electron emission element are generally well known. The electron emission elements emit electrons toward the phosphor layer, and the electrons excite the phosphor layer to cause the same to emit visible light. The light emission device may be used as a light source in a display device having a passive type (or non-self emissive type) of display panel.

The light emission unit includes a reflection layer covering one side of the phosphor layer that faces the rear substrate. The reflection layer functions to enhance the luminance of the light emission device by reflecting visible light, which is emitted from the phosphor layer toward the rear substrate, back to the front substrate. The reflection layer has a thickness of about several thousands of angstroms (Å) and a plurality of tiny holes for passing the electrons.

In the conventional light emission device, the reflection layer is manufactured by (i) forming an intermediate layer over the phosphor layer by using a polymer material that can decompose at a high temperature, (ii) vacuum depositing a metal material (e.g., aluminum) over the intermediate layer, and (iii) removing the intermediate layer by firing the intermediate layer. The intermediate layer has a surface roughness that is less than the surface roughness of the phosphor layer. Thus, the reflection layer also has minor surface roughness that is not related to the surface roughness of the phosphor layer.

However, when the intermediate layer decomposes into a gaseous material in the firing process, pressure caused by the decomposed gas may concentrate at one area of the reflection layer, thereby damaging the reflection layer. Since the damaged part of the reflection layer cannot reflect the visible light emitted from the phosphor layer, the light emission device has low luminance at the area corresponding to the damaged part of the reflection layer.

### SUMMARY OF THE INVENTION

Several aspects and example embodiments of the present invention provide a light emission device that can prevent damage to a reflection layer during a formation process of the reflection layer and improve luminance by enhancing the light reflection efficiency of a light emission unit, and a display device using the light emission device as a light source.

In accordance with an example embodiment of the present invention, a light emission device includes (i) first and second substrates facing each other with a predetermined distance therebetween; (ii) an electron emission unit located on one side of the first substrate, the electron emission unit including a plurality of electron emission elements; and (iii) a light emission unit located on one side of the second substrate, the light emission unit including at least one phosphor layer and a reflection layer spaced apart from the phosphor layer with a barrier disposed between the phosphor layer and the reflection layer.

According to an aspect of the present invention, a plurality of phosphor layers may be spaced apart from each other with a predetermined distance therebetween. A black layer may be disposed between the phosphor layers, and the barrier may be located on the black layer. Each of the phosphor layers may correspond to at least one electron emission element. The black layer and the barrier may be formed with a lattice pattern.

According to another aspect of the present invention, the barrier may be formed with a thickness of 30-1000 μm, and it may have a light reflection function. The reflection layer may be formed of a metal sheet with a thickness of 500-2000 Å and be attached to the barrier by using an adhesive material.

According to another aspect of the present invention, the electron emission element may include a cathode electrode, at least one electron emission region electrically connected to the cathode electrode, and a gate electrode intersecting the cathode electrode and insulated from the cathode electrode with a first insulation layer interposed between the cathode electrode and the gate electrode. The electron emission element may further include a focusing electrode located above the gate electrode with a second insulation layer interposed between the gate electrode and the focusing electrode. The light emission unit may include red phosphor layers, green phosphor layers, and blue phosphor layers spaced apart from each other at a predetermined distance.

According to another aspect of the present invention, the electron emission element may include a first electrode, a second electrode insulated from the first electrode and intersecting the first electrode, a first conductive layer electrically connected to the first electrode, a second conductive layer electrically connected to the second electrode and spaced apart from the first conductive layer, and an electron emission region disposed between the first and second conductive layers.

In accordance with another example embodiment of the present invention, a display device includes (i) a display panel for displaying an image, and (ii) a light emission device for emitting light toward the display panel. The light emission device includes (i) first and second substrates facing each other with a predetermined distance therebetween; (ii) an electron emission unit located on one side of the first substrate and including a plurality of electron emission elements; and (iii) a light emission unit located on one side of the second substrate and including at least one phosphor layer and a reflection layer spaced apart from the phosphor layer with a barrier disposed between the phosphor layer and the reflection layer.

According to an aspect of the present invention, the display panel includes first pixels and the light emission device includes second pixels. The number of second pixels may be less than that of the first pixels, and the luminance of each second pixel may be independently controlled. The display panel may be a liquid crystal display panel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial sectional view illustrating a light emission device according to an example embodiment of the present invention;

FIG. 2 is a partially cut-away perspective view illustrating the internal structure of an active area in the light emission device shown in FIG. 1;

FIG. 3 is an exploded perspective view illustrating a display device according to an example embodiment of the present invention;

FIG. 4 is a partial sectional view illustrating a display panel of the display device shown in FIG. 3;

FIG. 5 is a partially cut-away perspective view illustrating the internal structure of an active area in a light emission device according to another example embodiment of the present invention;

FIG. 6 is a partial sectional view illustrating a light emission device according to yet another example embodiment of the present invention; and

FIG. 7 is a partial top view illustrating an electron emission unit of the light emission device shown in FIG. 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In several aspects and example embodiments of the present invention, all of the light emission devices that can emit light to the outside are regarded as light emission devices. Therefore, all display devices that can transmit information by displaying symbols, letters, numbers, and pictorial images may be regarded as light emission devices. In addition, the light emission device may be used as a light source for emitting light to a passive type display panel.

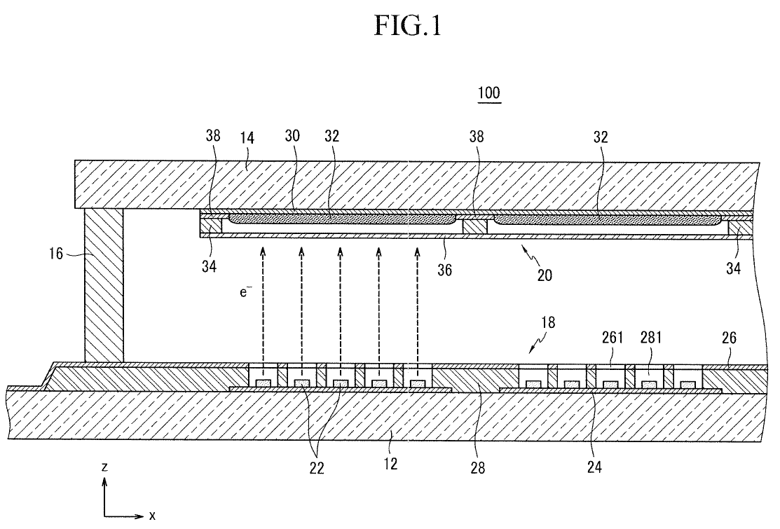

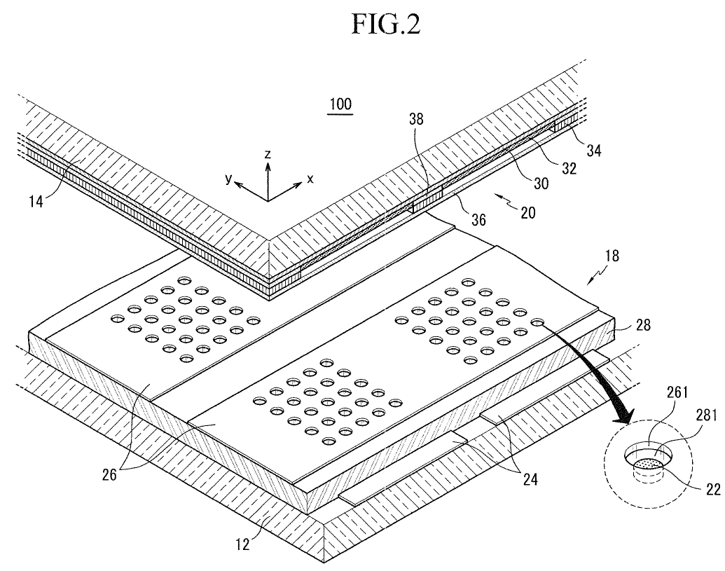

A light emission device according to an example embodiment of the present invention will be described with reference to FIGS. 1 and 2. In FIGS. 1 and 2, a light emission device 100 includes first and second substrates 12 and 14 arranged in parallel and to face each other at a predetermined interval. A sealing member 16 is provided to seal the peripheries of the first and second substrates 12 and 14 to form a vacuum vessel (or chamber). The inner space of the vacuum vessel is kept to a degree of vacuum of about 10⁻⁶ Torr.

Inside the sealing member 16, each of the first and second substrates 12 and 14 may be divided into an active area from which visible light is actually emitted and a non-active area surrounding the active area. An electron emission unit 18 for emitting electrons is provided on an inner surface of the first substrate 12 at the active area and a light emission unit 20 for emitting the visible light is provided on an inner surface of the second substrate 14 at the active area.

The second substrate 14 on which the light emission unit 20 is located may be a front substrate of the light emission device 100 and the first substrate 12 on which the electron emission unit 18 is located may be a rear substrate of the light emission device 100. Disposed between the first and second substrates 12 and 14 are spacers (not shown) that are able to withstand a compression force applied to the vacuum vessel and to uniformly maintain a gap between the first and second substrates 12 and 14.

In accordance with an example embodiment of the present invention, the electron emission unit 18 includes a plurality of electron emission elements of a field emission array (FEA) type. The electron emission elements of the electron emission unit 18 include electron emission regions 22 and driving electrodes for controlling electron emission of the electron emission regions 22. The driving electrodes include cathode electrodes 24 that are arranged in a linear and parallel pattern extending in a first direction (y-axis direction of FIG. 2) of the first substrate 12 and gate electrodes 26 that are arranged in a linear and parallel pattern extending in a second direction (x-axis direction of FIG. 2) perpendicular to the first direction. An insulation layer 28 is interposed between the cathode electrodes 24 and the gate electrodes 26.

Openings 261 and openings 281 are respectively formed in the gate electrodes 26 and the insulation layer 28 at each region where the cathode and gate electrodes 24 and 26 intersect each other to partially expose the cathode electrodes 24. The electron emission regions 22 are located on the cathode electrodes 24 in the openings 281 of the insulation layer 28.

The electron emission regions 22 are formed of a material that emits electrons when an electric field is formed around the regions under a vacuum atmosphere, such as a carbon-based material or a nanometer-sized material. For example, the electron emission regions 22 may include at least one of materials selected from the group consisting of carbon nanotubes, graphite, graphite nanofibers, diamonds, diamond-like carbon, fullerene (C60), silicon nanowires, and combinations thereof. Alternatively, the electron emission regions may be in the form of a pointed tip structure made of a molybdenum-based material or a silicon-based material.

In the above-described structures, one cathode electrode 24, one gate electrode 26, and the electron emission regions 22 located at one intersecting region of the cathode and gate electrodes 24 and 26 form a single electron emission element. One electron emission element may correspond to a single pixel region of the light emission device 100. Alternatively, two or more of the electron emission elements may correspond to a single pixel region of the light emission device 100.

The light emission unit 20 includes an anode electrode 30, phosphor layers 32 located on a surface of the anode electrode 30, and a reflection layer 36 spaced apart from the phosphor layers 32 with a barrier 34 interposed between the phosphor layers 32 and the reflection layer 36.

The anode electrode 30 is formed of a transparent conductive material, such as indium tin oxide (ITO), so that visible light emitted from the phosphor layers 32 can transmit through the anode electrode 30. The anode electrode 30 is an acceleration electrode that receives a high voltage (i.e., anode voltage) of thousands of volts or more to place the phosphor layers 32 in a high potential state.

The phosphor layers 32 may be formed of a mixture of red, green, and blue phosphors, which can collectively emit white light. The phosphor layers 32 may be spaced apart from each other with a predetermined interval, and a black layer 38 may be disposed between the phosphor layers 32. Each of the phosphor layers 32 may correspond to the single pixel region of the light emission device 100. Alternatively, one phosphor layer may be formed on an entire active area of the second substrate 14. FIGS. 1 and 2 show a case where the phosphor layers 32 are spaced apart from each other and the black layer 38 is disposed between the adjacent phosphor layers 32.

The barrier 34 is located on the black layer 38 with a predetermined thickness, and the reflection layer 36 is attached to one side of the barrier 34 facing the first substrate 12. The reflection layer 36 has a plurality of tiny holes for passing the electrons and functions to enhance the luminance of the light emission device 100 by reflecting the visible light, which is emitted from the phosphor layers 32 toward the first substrate 12, back to the second substrate 14.

The barrier 34 may be formed with a pattern identical to the black layer 38 or a certain pattern different from the black layer 38. In a case where the black layer 38 is formed with a lattice pattern, the barrier 34 may be formed with the lattice pattern. Alternatively, the barrier may be formed with a line pattern or a dot pattern.

The barrier 34 may be formed of a white insulation material to reflect the incident light toward the phosphor layers 32. When the barrier 34 is formed with the lattice pattern to surround each of the phosphor layers 32 corresponding to the single pixel region, the light reflection ability of the barrier 34 can be maximized.

The barrier 34 may have a thickness of about 30-1000 μm. When the thickness of the barrier 34 is less than 30 μm, the light reflection of the barrier 34 is barely realized. When the thickness of the barrier 34 is greater than 1000 μm, light is scattered between the phosphor layers 32 and the reflection layer 36, thereby decreasing the light reflection efficiency of the reflection layer 36.

The reflection layer 36 may be formed of a metal sheet (e.g., an aluminum sheet) and attached to the barrier 34 by using an adhesive material. The reflection layer 36 may have a thickness of about 500-2000 Å. When the thickness of the reflection layer 36 is less than 500 Å, a great part of the light, which is emitted from the phosphor layers 32, passes through the reflection layer 36, thereby decreasing the light reflection efficiency of the reflection layer 36. When the thickness of the reflection layer 36 is greater than 2000 Å, electron transmittance of the reflection layer 36 is reduced so that luminance of the phosphor layers 32 decreases.

In particular, the reflection layer 36 has a thickness of about 800-1200 Å. When the thickness of the reflection layer 36 is within that range, the light reflection efficiency and electron transmittance can be optimized. The anode electrode 30 formed of the transparent conductive material can be eliminated, and the reflection layer 36 can function as the anode electrode 30 upon receipt of an anode voltage.

The light emission device 100 is driven when a scan driving voltage is applied to one of the cathode and gate electrodes 24 and 26, a data driving voltage is applied to the other of the cathode and gate electrodes 24 and 26, and a positive direct current (DC) anode voltage of thousands of volts or more is applied to the anode electrode 30. Electric fields are formed around the electron emission regions 22 at the pixels where the voltage difference between the cathode and gate electrodes 24 and 26 is equal to or greater than the threshold value, and thus electrons are emitted from the electron emission regions 22. The emitted electrons collide with a corresponding portion of the phosphor layers 32 by being attracted by the anode voltage applied to the anode electrode 30, thereby exciting the phosphor layers 32.

In the light emission device 100, the light emission unit 20 has a structure in which the barrier 34 surrounds the edge of phosphor layers 32 and the reflection layer 36 covers one side of the phosphor layers 32 facing the first substrate 12. That is, each of the phosphor layers 32, along with the adjacent barriers 34, and the reflection layer 36 forms a plurality of spaces that are independently divided by the adjacent barriers 34. Accordingly, the light emission device 100 can enhance the light reflection efficiency of the light emission unit 20 and effectively prevent diffusion of the light emitted from a certain pixel region toward the adjacent pixel region.

In addition, since the light emission device 100 includes the barrier 34 and the reflection layer 36 formed of the metal sheet, it is not required to form an intermediate layer between the phosphor layers 32 and the reflection layer 36. Therefore, the light emission device 100 of this exemplary embodiment can eliminate the possibility of damage to the reflection layer 36 otherwise caused by a pressure applied to the reflection layer 36 during the firing process for an intermediate layer. Also, the manufacturing process for the light emission unit 20 can be simplified.

The light emission device 100 according to the above-described exemplary embodiment may be used as a light source for emitting white light for a display panel of a passive type (or a non-self emissive type). In the light emission device 100, the first and second substrates 12 and 14 may be spaced apart from each other by a relatively large distance of about 5-20 mm. By this relatively large distance between the first and second substrates 12 and 14, arcing in the vacuum vessel can be reduced and thus it becomes possible to apply a high voltage of above 10 kV, preferably of 10-15 kV, to the anode electrode 30.

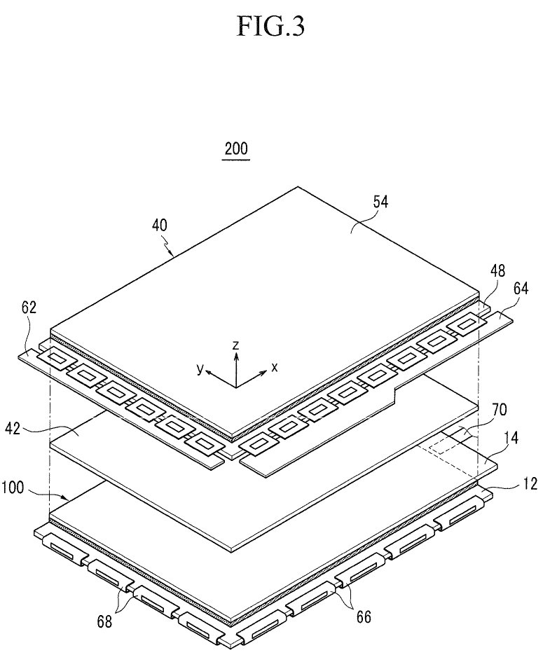

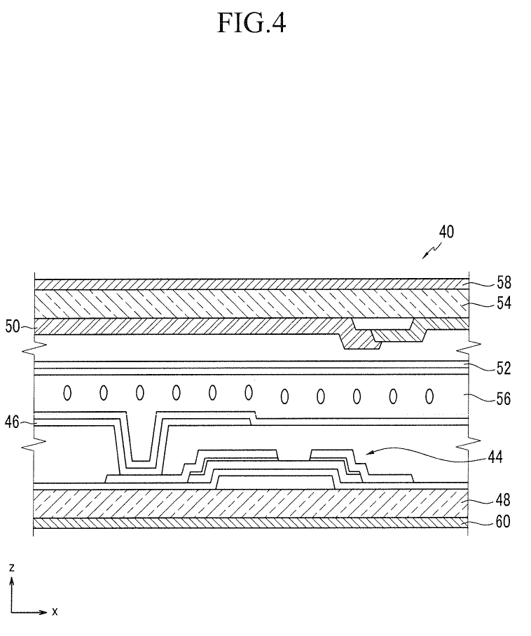

A display device using the above-described light emission device as a light source will be described with reference to FIGS. 3 and 4. Referring to FIG. 3, a display device 200 of this exemplary embodiment includes a light emission device 100 and a display panel 40 located in front of the light emission device 100. A light diffuser 42 for uniformly diffusing light emitted from the light emission device 100 to the display panel 40 may be located between the light emission device 100 and the display panel 40. The light diffuser 42 is spaced apart from the light emission device 100 by a predetermined distance.

A liquid crystal display panel or another passive type of display panel may be used as the display panel 40. In the following description, as an example, a case where the display panel 40 is a liquid crystal display panel will be explained.

Referring to FIG. 4, the display panel 40 includes a lower substrate 48 on which a plurality of thin film transistors (TFTs) 44 and a plurality of pixel electrodes 46 are formed, an upper substrate 54 on which a color filter layer 50 and a common electrode 52 are formed, and a liquid crystal layer 56 provided between the lower and upper substrates 48 and 54. Polarizing plates 58 and 60 are attached on a top surface of the upper substrate 54 and a bottom surface of the lower substrate 48 to polarize the light passing through the display panel 40.

A pixel electrode 46 is located for each sub-pixel, and TFT 44 controls the driving of the respective pixel electrode 46. The pixel electrodes 46 and the common electrode 52 are formed of a transparent conductive material. The color filter layer 50 includes red, green, and blue layers arranged to correspond to respective sub-pixels. Three sub-pixels, i.e., the red, green, and blue layers that are located side by side, define a single pixel.

When the TFT 44 of a predetermined sub-pixel is turned on, an electric field is formed between the pixel electrode 46 and the common electrode 52. A twisting angle of liquid crystal molecules of the liquid crystal layer 56 is varied thereby, in accordance with which the light transmittance of the corresponding sub-pixel is varied. The display panel 40 realizes a predetermined luminance and color for each pixel by controlling the light transmittance of the sub-pixels.

In FIG. 3, reference numeral 62 denotes a gate circuit board assembly for transmitting gate driving signals to each of the gate electrodes of the TFTs 44, and reference numeral 64 denotes a data circuit board assembly for transmitting data driving signals to each of the source electrodes 46 of the TFTs 44. Referring to FIG. 3, the light emission device 100 includes a plurality of pixels, the number of which is less than the number of pixels of the display panel 40, so that one pixel of the light emission device 100 corresponds to two or more pixels of the display panel 40. Each pixel of the light emission device 100 emits light in response to the highest gray level among gray levels of the corresponding pixels of the display panel 40. The light emission device 100 can represent a gray level of 2 to 8 bits at each pixel.

For convenience, the pixels of the display panel 40 are referred to as first pixels and the pixels of the light emission device 100 are referred to as second pixels. The first pixels corresponding to one second pixel are referred to as a first pixel group. In the driving process of the light emission device 100, a signal control unit (not shown) that controls the display panel 40 (i) detects the highest gray level of the first pixel group, (ii) activates the gray level required for emitting light from the second pixel in response to the detected high gray level and converts the activated gray level into digital data, (iii) generates a driving signal of the light emission device 100 using the digital data, and (iv) applies the driving signal to the light emission device 100.

The driving signal of the light emission device 100 includes scan driving signals and data driving signals. For example, the scan driving signals are applied to the gate electrodes 26 as shown for example in FIGS. 1 and 2 while the data driving signals are applied to the cathode electrodes 24 as shown for example in FIGS. 1 and 2.

Scan and data circuit board assemblies (not shown) of the light emission device 100 may be located on the rear surface of the light emission device 100. In FIG. 3, reference numeral 66 denotes first connectors for electrically connecting the cathode electrodes and the data circuit board assembly, and reference numeral 68 denotes second connectors for electrically connecting the gate electrodes and the scan circuit board assembly. Reference numeral 70 denotes a third connector for applying an anode voltage to the anode electrode.

When an image is displayed on the first pixel group, the corresponding second pixel of the light emission device 100 emits light with a predetermined gray level by synchronizing with the first pixel group. That is, the light emission device 100 independently controls the luminance of each pixel and thus provides the proper intensity of light to the corresponding pixels of the display panel 40 in proportion to the luminance of the first pixel group. As a result, the display device 200 of the present exemplary embodiment can enhance the contrast ratio of the screen, thereby improving the display quality.

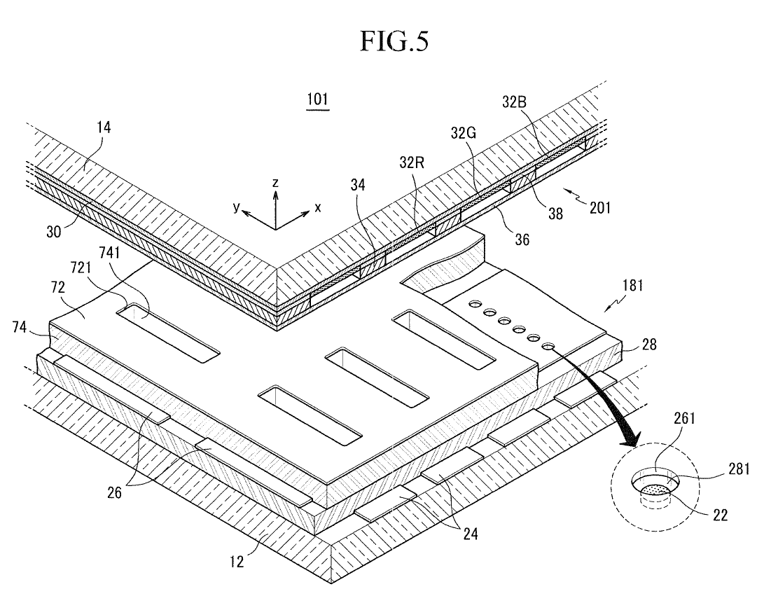

A light emission device according to a second exemplary embodiment of the present invention will be described with reference to FIG. 5. The same elements as of the first exemplary embodiment are denoted by the same reference numerals. Referring to FIG. 5, an electron emission unit 181 in a light emission device 101 of this exemplary embodiment further includes a focusing electrode 72 disposed above the gate electrodes 26. If the insulation layer 28 located between the cathode electrodes 24 and the gate electrodes 26 is referred to as a first insulation layer, a second insulation layer 74 is provided between the gate electrodes 26 and the focusing electrode 72.

Openings 721 and openings 741 for passing electrons are respectively formed in the focusing electrode 72 and the second insulation layer 74. The focusing electrode 72 is applied with 0 V or a negative direct current (DC) voltage of several through tens of volts to converge electrons on the central portion of a bundle of electron beams passing through the openings 721 of the focusing electrode 72.

Each of the regions where the cathode electrodes 24 intersect the gate electrodes 26 may be formed to have a size that is smaller than that of the first exemplary embodiment. The number of electron emission regions 22 provided in each of the regions where the cathode electrodes 24 intersect the gate electrodes 26 may be less than that of the first exemplary embodiment.

A light emission unit 201 includes red phosphor layers 32R, green phosphor layers 32G, and blue phosphor layers 32B that are spaced apart from each other, and a black layer 38 that is located between respective phosphor layers 32R, 32G, and 32B. A barrier 34 is located on the black layer 38 and a reflection layer 36 is attached to the barrier 34.

Each of the regions where the cathode electrodes 24 intersect the gate electrodes 26 corresponds to a single sub-pixel region of the light emission device 101. The red, green, and blue phosphor layers 32R, 32G, and 32B are arranged to correspond to respective sub-pixel regions. Three sub-pixels, i.e., the red, green, and blue phosphor layers 32R, 32G, and 32B that are located side by side define a single pixel.

The electron emission flux at each sub-pixel is controlled by driving voltages applied to the cathode electrodes 24 and the gate electrodes 26. The electrons emitted from the electron emission regions 22 collide with the phosphor layers 32R, 32G, and 32B of corresponding sub-pixels, thereby exciting the phosphor layers 32R, 32G, and 32B. The light emission device 101 realizes a predetermined luminance and color for each pixel by controlling the electron emission flux of the sub-pixels, thereby displaying a color image. While it has been described in the first and second exemplary embodiments that the electron emission units 18 and 181 are of a field emission array (FEA) type, the electron emission unit may be formed of a surface-conduction emission (SCE) type.

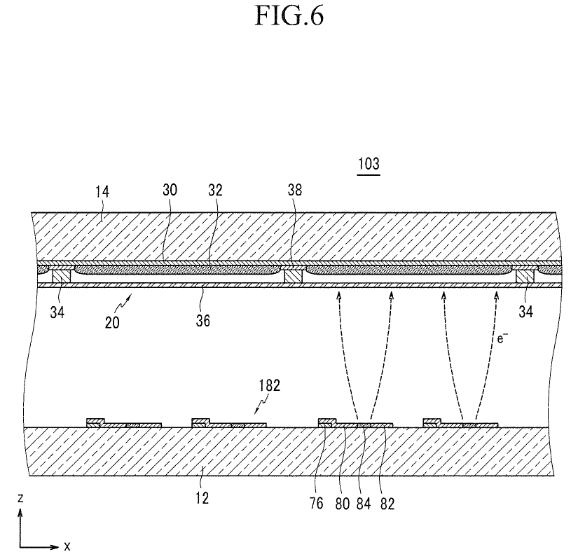

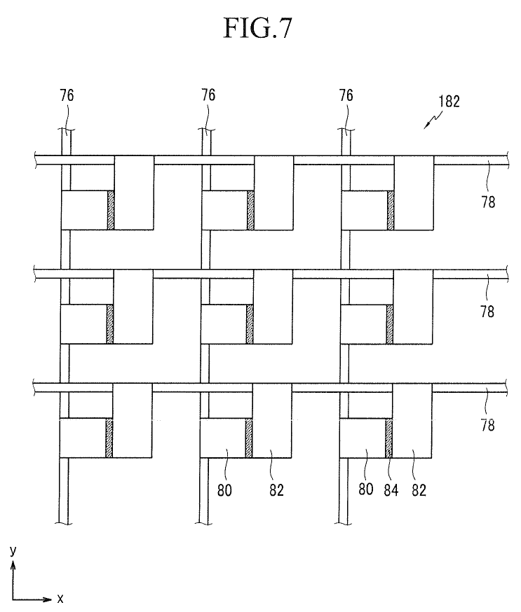

A light emission device according to yet another example embodiment of the present invention will be described with reference to FIGS. 6 and 7. Referring to FIGS. 6 and 7, a light emission device 103 has the same construction as that of the light emission devices shown in FIGS. 1 and 5 except that an electron emission unit 182 is formed of the SCE type. FIG. 6 shows the light emission unit 20 provided in the light emission device as an example. The same elements as shown in FIG. 1 are denoted herein below.

The electron emission unit 182 includes first electrodes 76 extended in a first direction (y-axis direction of FIG. 7) of the first substrate 12, second electrodes 78 extended in a second direction (x-axis direction of FIG. 7) perpendicular to the first direction and insulated from the first electrodes 76, first conductive layers 80 connected to each of the first electrodes 76, second conductive layers 82 connected to each of the second electrodes 78 and spaced apart from the first conductive layers 80, and electron emission regions 84 disposed between the first and second conductive layers 80 and 82.

The electron emission regions 84 may be formed of a carbon-based material. For example, the electron emission regions 84 may include at least one of materials selected from the group consisting of carbon nanotubes, graphite, graphite nanofibers, diamond-like carbon, fullerene (C60), and combinations thereof. Alternatively, the electron emission regions may be formed by fine cracks provided between the first and second conductive layers 80 and 82.

In the above-described structure, one first electrode 76, one second electrode 78, one first conductive layer 80, one second conductive layer 82, and one electron emission region 84 form a single electron emission element. One electron emission element or a plurality of electron emission elements may correspond to the single pixel region of the light emission device 103.

When voltages are applied to the respective first and second electrodes 76 and 78, a current flows in a direction parallel with the surface of the electron emission region 84 through the first and second conductive layers 80 and 82, thereby realizing the surface-conduction emission from the electron emission region 84.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A light emission device comprising:
first and second substrates arranged in parallel and separated by a predetermined distance;
an electron emission unit located on one side of the first substrate facing the second substrate, the electron emission unit including a plurality of electron emission elements; and
a light emission unit located on one side of the second substrate facing the first substrate,
wherein the light emission unit includes a reflection layer and at least one phosphor layer and the reflection layer is spaced apart from the phosphor layer with a plurality of barriers disposed between the phosphor layer and the reflection layer.

2. The light emission device of claim 1, wherein a plurality of phosphor layers are spaced apart from each other with a predetermined distance therebetween, a black layer is disposed between the phosphor layers, and the barriers are located on the black layer.

3. The light emission device of claim 2, wherein each of the phosphor layers corresponds to at least one electron emission element, and the black layer and the barrier are formed with a lattice pattern.

4. The light emission device of claim 1, wherein the barrier is formed with a thickness of 30-1000 μm.

5. The light emission device of claim 4, wherein the barrier has a light reflection function.

6. The light emission device of claim 1, wherein the reflection layer is formed with a thickness of 500-2000 Å.

7. The light emission device of claim 6, wherein the reflection layer is formed of a metal sheet and is attached to the barrier with an adhesive material.

8. The light emission device of claim 1, wherein the electron emission element includes a cathode electrode, at least one electron emission region electrically connected to the cathode electrode, and a gate electrode intersecting the cathode electrode and insulated from the cathode electrode with a first insulation layer interposed between the cathode electrode and the gate electrode.

9. The light emission device of claim 8, wherein the electron emission element further includes a focusing electrode located above the gate electrode with a second insulation layer interposed between the gate electrode and the focusing electrode, and the light emission unit includes red phosphor layers, blue phosphor layers, and green phosphor layers spaced apart from each other with a predetermined distance therebetween.

10. The light emission device of claim 1, wherein the electron emission element includes a first electrode, a second electrode insulated from the first electrode and intersecting the first electrode, a first conductive layer electrically connected to the first electrode, a second conductive layer electrically connected to the second electrode and spaced apart from the first conductive layer, and an electron emission region disposed between the first and second conductive layers.

11. A display device comprising:
a display panel to display an image, and
a light emission device to emit light toward the display panel for a visual display of the image,
wherein the light emission device includes:
first and second substrates arranged in parallel and separated by a predetermined distance;
an electron emission unit located on one side of the first substrate facing the second substrate, the electron emission unit including a plurality of electron emission elements; and
a light emission unit located on one side of the second substrate facing the first substrate, the light emission unit including at least one phosphor layer and a reflection layer spaced apart from the phosphor layer with a barrier disposed between the phosphor layer and the reflection layer.

12. The display device of claim 11, wherein a plurality of phosphor layers are spaced apart from each other with a predetermined distance therebetween, a black layer is disposed between the phosphor layers, and the barrier is located on the black layer.

13. The display device of claim 12, wherein each of the phosphor layers corresponds to at least one electron emission element, and the black layer and the barrier are formed with a lattice pattern.

14. The display device of claim 11, wherein the barrier has a light reflection function and a thickness of 30-1000 μm.

15. The display device of claim 11, wherein the reflection layer is formed of a metal sheet having a thickness of 500-2000 Å.

16. The display device of claim 11, wherein the display panel includes first pixels and the light emission device includes second pixels, the number of second pixels is less than the number of first pixels, and luminance of each second pixel is independently controlled.

17. The display device of claim 16, wherein the display panel is a liquid crystal display panel.

18. A method of emitting light from a light emission device comprising a first and second substrate, an electron emission unit disposed on the first substrate and having cathode and gate electrodes and electron emission regions for emitting electrons, a light emission unit disposed on the second substrate facing the first substrate and having an anode electrode for attracting emitted electrons, a reflection layer formed on the anode electrode, and at least one phosphor layer disposed between the reflection layer and the anode electrode, the method comprising:
applying a scan driving voltage to one of the cathode and gate electrodes of the electron emission unit;
applying a data driving voltage to the other of the cathode and gate electrodes of the electron emission unit; and
applying an anode voltage to the anode electrode of the light emission unit so as to attract electrons emitted from the electron emission unit for creating light.

19. The light emission device of claim, 6, wherein the thickness of the reflection layer is 800-1200 Å.

20. The light emission device of claim 9, wherein:
openings are formed in the gate electrodes, the first insulation layer, the focusing electrode and the second insulation layer at each region where the cathode and gate electrodes intersect,
electron emission regions are located on the cathode electrodes in the openings, and
the focusing electrode voltage is a direct current voltage from 0 V to tens of negative volts.
